(19) United States
(12) Patent Application Publication
(10) Pub. No.: US 2012/0199604 A1
(43) Pub. Date: Aug. 9, 2012

(54) Bar Soap Holder and Dispenser

(76) Inventor: Maximus Brown, Brooklyn, NY (US)

(21) Appl. No.: 13/293,511

(22) Filed: Nov. 10, 2011

Related U.S. Application Data
(60) Provisional application No. 61/462,795, filed on Feb. 8, 2011.

(51) Int. Cl. G07F 11/16

(52) U.S. Cl. 221/289

(57) ABSTRACT

A bar soap holder and dispenser is disclosed. In a particular embodiment, the device includes a base having an upper portion and a lower portion, where the upper portion includes a rear wall and a pair of side walls. The device also includes an open front side of the upper portion adapted to receive and store a plurality of bars of soap stacked therein and a cover adapted to pivotally swing from a closed to an open position over the upper portion of the device, where the cover encloses the front side of the upper portion when in the closed position. A push button is disposed within the lower portion of the base and adapted to dispense a bar of soap outwards from the lower portion of the base when the push button is pushed.

### I. CROSS REFERENCE TO RELATED APPLICATIONS

This application claims the benefit of Provisional Application No. 61/462,795 filed Feb. 8, 2011. The disclosure of the provisional application is incorporated herein by reference.

### II. FIELD OF THE DISCLOSURE

The present disclosure is generally related to a bar soap holder and dispenser.

### III. BACKGROUND

Soap dishes are often used to store bars of soap within a shower stall or on a bathtub ledge. Water that contacts the soap bar promotes the dissolving of the soap or causing the outer surface of the soap bar to become soft and easily to break apart thus reducing the life of the soap bar. Accordingly, there is a need for a device that increases the life of the soap bar. There is also a need in the art for a device that stores bars of soap so that each bar of soap is readily available when needed. Shortcomings of the prior art soap dispensers include dispensers that include many moving parts that are expensive to manufacture and are susceptible to becoming dirty, dispensers that are incapable of storing several bars of soap, and dispensers that are otherwise lacking in aesthetics and the ability to conform to bathroom décor.

It is, therefore, to the effective resolution of the aforementioned problems and shortcomings of the prior art that the present invention is directed.

However, in view of the prior art at the time the present invention was made, it was not obvious to those of ordinary skill in the pertinent art how the identified needs could be fulfilled.

### IV. SUMMARY

A bar soap holder and dispenser is disclosed. In a particular embodiment, the device includes a base having an upper portion and a lower portion, where the upper portion includes a rear wall and a pair of side walls. The device also includes an open front side of the upper portion adapted to receive and store a plurality of bars of soap stacked therein and a cover adapted to pivotally swing from a closed to an open position over the upper portion of the device, where the cover encloses the front side of the upper portion when in the closed position. A push button is disposed within the lower portion of the base and adapted to slide inwards upon an application of a horizontal force. In addition, the device includes a distributor having a pair of legs and a cross member interposed therebetween, where the pair of legs are adapted to dispense a bar of soap outwards from the lower portion of the base in response to the push button being pushed.

One particular advantage provided by embodiments of the bar soap holder and dispenser device is the ability of the device to store several bars of soap in vertical orientation. This is particularly advantageous to dispense a bar of soap from the bottom of the device allowing the next bar to drop down in its place. Accordingly, a new bar of soap is always ready when needed. A vertical slot in the cover may be used to indicate how many bars of soap remain within the device and to indicate when it is time to refill the device with more bars of soap.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a front view of a particular embodiment of a bar soap holder and dispenser;

FIG. 2 is a top view of the bar soap holder and dispenser of FIG. 1;

FIG. 3 is an elevational view of the bar soap holder and dispenser of FIGS. 1 and 2;

FIG. 4 is rear view of the bar soap holder and dispenser of FIGS. 1-3;

FIG. 5 is a partial cross sectional view along line 5-5 of FIG. 4 of a push button and a distributor assembly used to dispense a bar of soap;

FIG. 6 is a partial cross sectional view along line 5-5 of FIG. 4 with the push button depressed to activate the distributor to dispense the bar of soap;

FIG. 7 is a bottom view along line 7-7 of FIG. 5 of the push button and distributor;

FIG. 8 is a rear view along line 8-8 of FIG. 5 of the push button and distributor;

FIG. 9 is a top view along line 9-9 of FIG. 3 of a soap tray of the bar soap holder and dispenser; and

FIG. 10 is a partial cross sectional view along line 10-10 of FIG. 9 of a soap tray of the bar soap holder and dispenser.

### VI. DETAILED DESCRIPTION

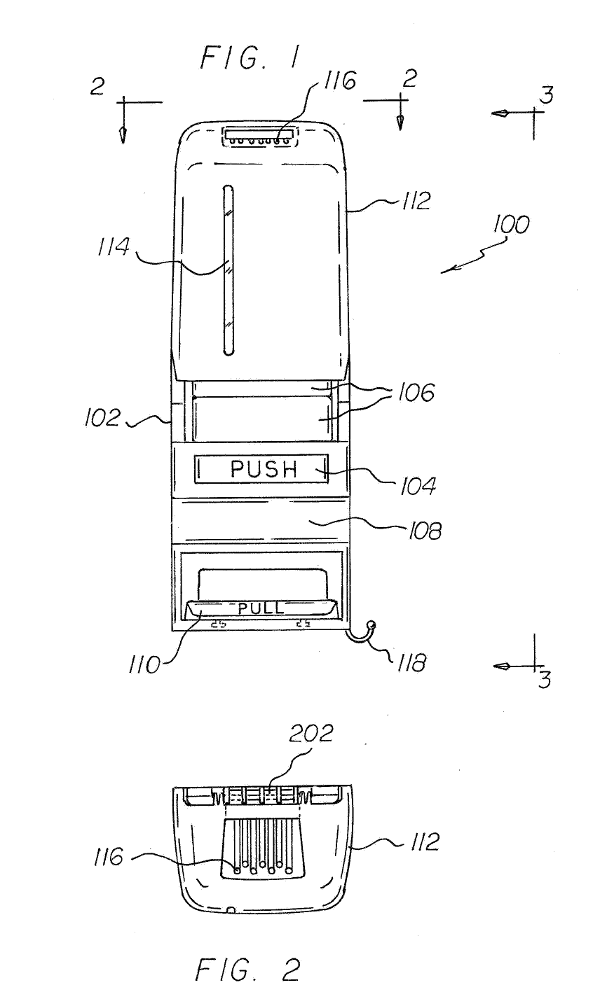

Referring to FIGS. 1 and 2, a particular illustrative embodiment of a bar soap holder and dispenser is disclosed and generally designated 100. The dispenser 100 includes a base 102 and a cover 112. The cover 112 is used to cover bars of soap 106 that are stacked and stored within the base 102. The lowest bar of soap 106 is visible and not covered by the cover 112 and sits on a ledge within the base 102 just above a push button 104. Below the push button 104, is an opening with a platform 108 within the base 102 that can be used to store a sponge, for example, or other hygienic products. A soap tray 110 is disposed at the bottom of the base 102, where the tray 110 is adapted to slide in and out as needed. A hook 118 may also be disposed proximate the bottom of the base 102 and used to hang a washcloth or other similar item. A vertical slot 114 is disposed in the cover 112 and used to determine the number of bars of soap 106 within the dispenser 100. Accordingly, a user may easily determine when the dispenser 100 is required to be refilled with additional bars of soap 106. Also disposed within the cover 112, is at least one aperture or series of slots that allows a scent of the bars of soap 106 to escape from the dispenser 100 and permeate a room with a pleasing aroma. This is particularly advantageous in a bathroom to keep the bathroom smelling fresh and clean.

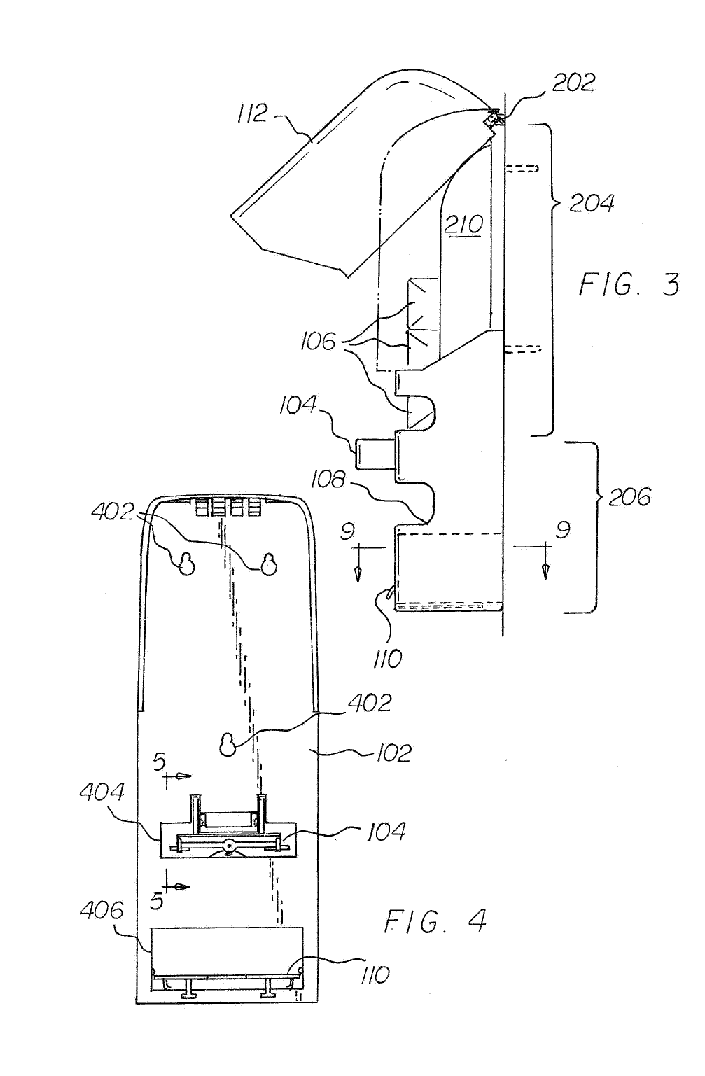

The base 102 includes an upper portion 204 and a lower portion 206, as shown in FIG. 3. The cover 112 is adapted to pivotally rotate from a closed to an open position over the upper portion 204 of the base 204 using a cover hinge 202 connecting the cover 112 to the upper portion 204 of the base 102. The cover 112 encloses the front side of the upper portion 204 when in the closed position.

As best illustrated in FIG. 3, the upper portion 204 of the base 102 includes a rear wall and a pair of side walls 210 to support the stack of bars of soap 106 snugly within the base 102. An open front side of the upper portion 204 is used to place and stack the bars of soap 106 within the dispenser 100. Both sides of the base 102 includes partial cut-outs to allow a user to easily access an item stored on the platform 108 and to grasp a bar of soap 106 when being it is being dispensed. As can be seen in FIG. 3, the push button 104 protrudes from a front side of the base 102. In addition, a lip of the soap tray 110 is visible in this side view and the lip is used by the user to grasp and pull the tray 110 outwards as needed to access the soap tray 110.

The push button 104 is disposed within the lower portion 206 of the base 102 and adapted to slide inwards upon an application of a horizontal force.

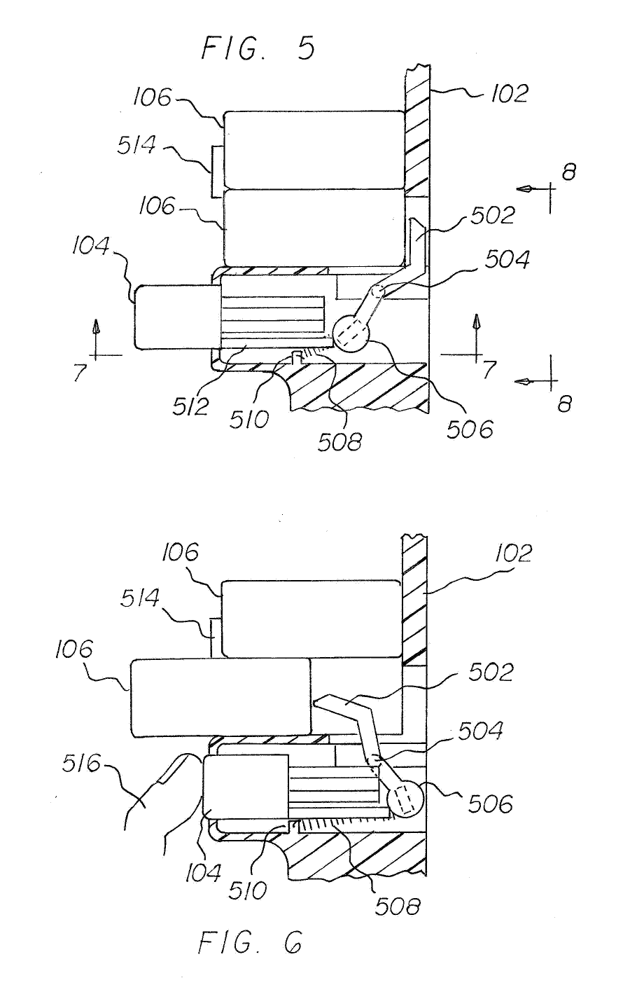

Referring now to FIG. 4, the rear of the dispenser 100 includes apertures 402 that may be used to secure the dispenser 100 to a wall using screws, for example. Also illustrated in FIG. 4, is a rear view of the button 104 and distributor assembly used to dispense a bar of soap 106. An aperture 404 in the rear of the base 102 includes two vertical slots that allows a pair of legs of a distributor illustrated in FIGS. 5-8 to retract into the base 102 when not dispensing a bar of soap 106. The aperture 406 for the soap tray 110 is also visible. As can be seen in FIG. 4, the soap tray 110 is supported by, and slides above, two projections that slide within two longitudinal slots of the base 102.

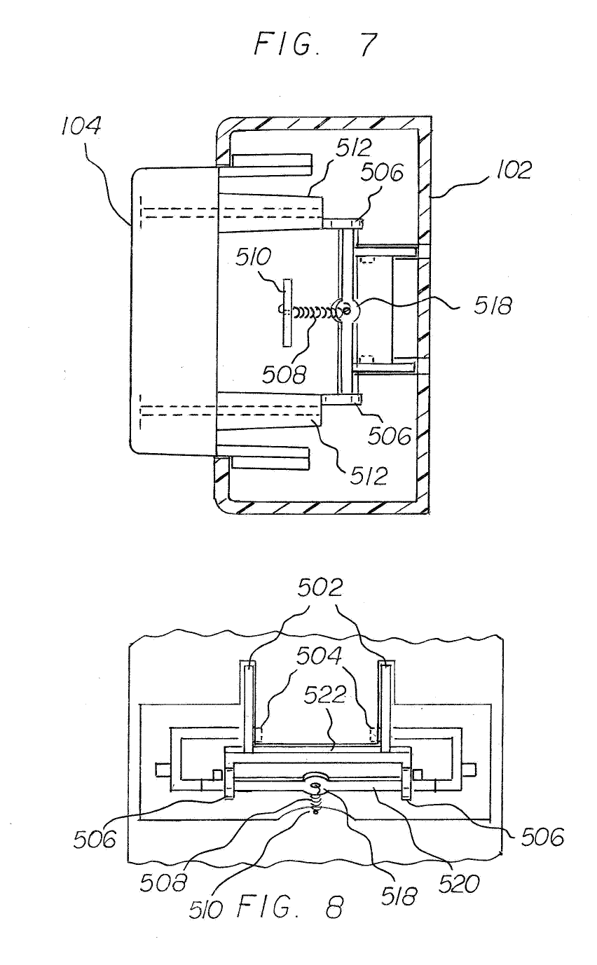

FIGS. 5 and 6 are partial cross sectional views along line 5-5 of FIG. 4 of the push button 104 and a distributor assembly used to dispense a bar of soap 106. The distributor assembly includes a pair of legs 502 and a cross member 520 (see FIG. 8) interposed therebetween. The pair of legs 502 are adapted to dispense a bar of soap 106 outwards from the lower portion 206 of the base 102 when the push button 104 is pushed. In operation, as the front of the push button 104 is pushed and slid inwards by a user's finger 516, lateral projections 512 disposed on the rear of the push button 104 engage a disk 506 on a lower end of the legs 502. The lower end of the legs 502 are pushed inwards by the push button 104, which in response causes the upper end of the legs 502 to rotate outwards about a pivot point 504 in a pendulum motion. The upper end of the legs 502 push the lowest bar of soap 106 out so that a user may easily grab the bar of soap 106 from the soap platform. As the push button 104 is depressed, a spring 508 is contemporaneously placed under tension. Accordingly, as the user releases the pressure on the push button 104, the spring 508 pulls the lower end of the legs 502 back into position and thus rotating the upper end of the legs 502 into the retracted position. Once the user has removed the lowest bar of soap 106 from the stack, the next bar of soap that is positioned directly above the lowest bar of soap 106 drops down into position on to the soap platform and becomes the new lowest bar of soap 106.

Referring now to FIG. 7, which is a bottom view along line 7-7 of FIG. 5 of the push button and distributor, the spring 508 is connected between the cross member 520 and an attachment point 510 on the base 102, where the spring 520 is adapted to bias the legs 502 in a retracted position as shown in FIG. 5. Integrated projections and grooves 512 along the sides of the push button 104 and base 102, respectively, allows the push button 104 to slide easily inwards and outwards in a controlled fashion. The projections 512 are configured to engage the disks 506 at the lower ends of the legs 502 when the push button 104 is pushed to dispense a bar of soap 106.

FIG. 8 is a rear view along line 8-8 of FIG. 5 of the push button and distributor and a partial enlarged view of FIG. 4 of the rear of the base 102. The legs 502 are adapted to rotate about a pivot point 504 when pressure is applied to the lower end of the legs 502 by the push button 104. The spring 508 is secured between the cross member 520 and an attachment point 510 of the base 102 so that when the push button 104 causes the legs 502 to rotate, the spring 508 is placed under tension and automatically returns the legs 502 to a retracted position when the push button 104 is released by the user.

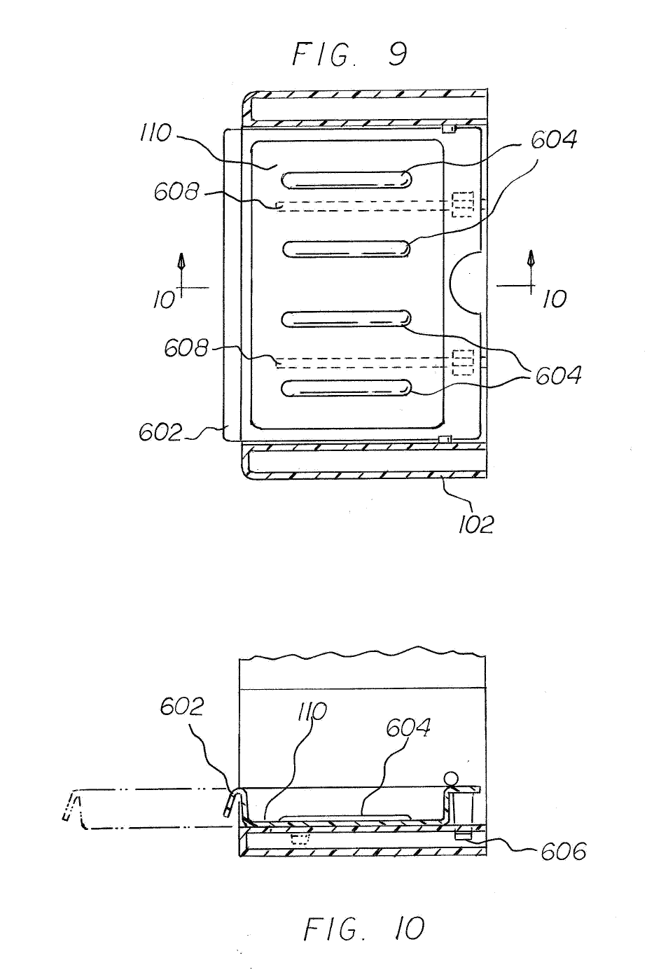

Referring now to FIG. 9, which is a top view along line 9-9 of FIG. 3, the drainage slots 604 allow water to pass through the tray 110 so that a bar of soap 106 that may stored thereon is allowed to dry out rather than be dissolved by collected water. The slots 604 are sized appropriately so that a bar of soap cannot pass through. A pair of longitudinal grooves or slots 608 are disposed in the base 102 and upon which the tray 110 can slide in and out of the base 102. FIG. 10 is a partial cross sectional view along line 10-10 of FIG. 9 of the soap tray of the bar soap holder and dispenser and further illustrates the projections 606 of the tray 110 that allows the tray 110 to slide in and out of the base 102 along grooves 608. Also visible in FIG. 10 is the periphery of each slot 604 of the tray 110 being slightly raised to support the bar of soap 106 above the bottom surface of the tray and to promote additional air circulation.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 R. §1.52(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A bar soap holder and dispenser device, the device comprising:
a base having an upper portion and a lower portion, wherein the upper portion having a rear wall and a pair of side walls;
an open front side of the upper portion adapted to receive and store a plurality of bars of soap stacked therein;
a cover adapted to pivotally swing from a closed to an open position over the upper portion of the device, wherein the cover encloses the front side of the upper portion when in the closed position;
a push button disposed within the lower portion of the base and adapted to slide inwards upon an application of a horizontal force; and
a distributor having a pair of legs and a cross member interposed therebetween, wherein the pair of legs adapted to dispense a bar of soap outwards from the lower portion of the base when the push button is pushed.

2. The bar soap holder and dispenser device of claim 1, further comprising a spring connected between the cross member and the base, wherein the spring is adapted to bias the pair of legs in a retracted position.

3. The bar soap holder and dispenser device of claim 2, the lower potion of the base further comprising a soap platform above the push button from which the bar of soap is dispensed.

4. The bar soap holder and dispenser device of claim 3, the upper portion of the base further comprising a retaining strap that spans the open front side of the upper portion and adapted to retain the plurality of bars of soap stacked within the upper portion when the cover is in the open position.

5. The bar soap holder and dispenser device of claim 4, wherein a front side of the cover comprising a vertically disposed slot that serves as an indictor as to a number of the bars of soap contained within the upper portion of the device.

6. The bar soap holder and dispenser device of claim 5, wherein a top side of the cover comprising at least one aperture adapted to allow a scent of the bars of soap contained within the upper portion to escape.

7. The bar soap holder and dispenser device of claim 6, the lower portion of the base further comprising a storage slot below the push button and adapted to store a sponge therein.

8. The bar soap holder and dispenser device of claim 7, further comprising a removable soap tray installed within the lower portion of the base, wherein the soap tray is adapted to slide in and out from the base.

9. The bar soap holder and dispenser device of claim 8, the soap tray further comprising at least one drainage slot to allow water to drain through the soap tray.

10. A bar soap holder and dispenser device, the assembly comprising:
a base adapted to store bars of soap therein;
a push button adapted to be pushed; and
a slot disposed within a bottom portion of the base and adapted to dispense one bar of soap at a time in response to the push button being pushed.

11. The bar soap holder and dispenser device of claim 10, the bottom portion of the base further comprising a pair of longitudinal slots for receiving a pair of reciprocal projections on either side of the push button, wherein the longitudinal slots are adapted to guide the push button when pushed.

12. The bar soap holder and dispenser device of claim 11, further comprising a distributor adapted to slide the one bar of soap outwards from the slot disposed within the bottom portion of the base.

13. The bar soap holder and dispenser device of claim 12, the distributor further comprising a pair of legs, wherein a first end of each leg is secured to a cross member and an interior surface of each leg having a circular projection to pivot about.

14. The bar soap holder and dispenser device of claim 13, further comprising a spring secured to the cross member and adapted to bias the push button outwards.

15. The bar soap holder and dispenser device of claim 14, the cross member further comprising a disk on opposing ends of the cross member, wherein the disks are adapted to engage the push button when pushed.

16. The bar soap holder and dispenser device of claim 15, further comprising a soap tray secured to a bottom portion of the base.

17. The bar soap holder and dispenser device of claim 16, wherein the soap tray further comprising a plurality of drainage slots to allow water to drain through the tray.

18. The bar soap holder and dispenser device of claim 17, wherein the soap tray is adapted to slide out from the bottom portion of the base.

19. The bar soap holder and dispenser device of claim 18, further comprising apertures for hanging the device on a wall.

20. A bar soap holder and dispenser device, the device comprising:
a base adapted to receive and store a plurality of bars of soap stacked therein;
a cover adapted to pivotally swing from a closed to an open position over the upper portion of the device; and
a push button adapted to dispense a bottom bar of soap of the plurality of bars of soap when the push button is pushed and an adjacent bar of soap drops down in its place.
